(19) United States
(12) Patent Application Publication
(10) Pub. No.: US 2021/0041122 A1
(43) Pub. Date: Feb. 11, 2021

(54) Detecting system of liquid leakage inside the duct and the method thereof

(71) Applicants: CHUNG YUAN CHRISTIAN UNIVERSITY, Tao-Yuan (TW); CASTING MACHINING ENGINEERING CO., LTD., Hunan Province (CN)

(72) Inventors: Yi-Hua Fan, Tao-Yuan (TW); Hsiang Kao, Hunan Province (CN)

(21) Appl. No.: 16/532,574

(22) Filed: Aug. 6, 2019

(51) Int. Cl. F24F 11/36; F24F 13/02; F24F 11/84

(52) U.S. Cl. CPC F24F 11/36; F24F 2140/30; F24F 11/84; F24F 13/0236

(57) ABSTRACT

The present invention provides a detecting system and method of liquid leakage inside the duct, which is used when the liquid is not transported inside the duct. The detecting system comprises: a duct, a detecting device, a signal processing device. The detecting device is fixed to the wall inside the duct. And the detecting device is used for starting detection when the liquid is not delivered inside the duct. When the liquid activates the detecting device, the detecting device sends a signal to the signal processing device for subsequent processing.

### FIELD OF THE INVENTION

The present invention relates to a detecting system and method of liquid leakage inside the duct, especially to a detecting system and method of liquid leakage inside the duct designed particularly for when liquid is not transported inside the duct.

### BACKGROUND OF THE INVENTION

The design is simple, economical and efficient. When the sensor detects the leakage, the signal would be transmitted to the operator and the operator could take emergency measures immediately. The device could also be connect with PLC control center. The central control system could shut down the power to stop the operation and prevent the possibilities of adverse consequences.

With the advancement of industrial technology, the quality of products is continuously improved, and the production equipment used must be required to achieve a certain appropriate rate and improve its performance in the process; for example, in the production process. The reliability of the liquid delivery system is used to ensure the delivery quality of the liquid.

In precision products or food processes, it is often necessary to go through multiple complex process steps from the start of production to completion. Each product process needs to be carried out using a variety of different addition solutions. These additional liquids are delivered to the machine to be processed using a solution transfer line to provide the solution required for each machine process.

Conventionally, under normal conditions, the flow and flow rate of the liquid are measured in the pipeline.

In addition, it is generally used to determine whether or not a leak is outside the pipeline, and the method is to randomly place a plurality of detectors on the floor below the pipeline.

However, as the precision of the product increases or the food is refined, the detection method of leakage is also important for the pipeline inside.

However, conventional hemispherical valves often cause tilting or damage of the valve seat and the valve stem due to excessive use. And causing the hemisphere valve to leak, lead to the amount of added liquid is not as expected. Slight, resulting in product quality is not up to standard. In severe cases, food quality deterioration causes food safety hazards.

In addition, it was found that when a product abnormality occurs due to liquid leakage in the pipeline, often separated by more than a period of time, and the addition of liquid has affected a considerable number of products. The conventional solution is to use artificial detection methods. For characteristics of product anomalies, check everyone production line, to find out the pipeline there may be a place where liquid leaks. This method is not only labor-intensive, and it will cause great delays in the production line and equipment maintenance. But the creator knows about the prior art, it was found that there is no set of standards or devices for in-line leak detection that can solve the above problems. And there is the creation of this produce.

### SUMMARY OF THE IVENTION

The present invention proposes a detecting system and method of liquid leakage inside the duct. Especially, the detecting system and method of liquid leakage inside the duct in the present invention are used when the liquid is not transported inside.

In light of the above background, in order to fulfill the requirements of industries, one object of the present invention is to provide a detecting system and method of liquid leakage inside the duct, which is used when the liquid is not transported inside the duct to use a simple and low cost method to obtain a the detection method of leakage. One object of the present invention is to provide a detecting system of liquid leakage inside the duct, which is used when the liquid is not transported inside the duct, comprising: a duct; a detection component; and a signal processing component; wherein the detection component is fixed to the wall inside the duct; wherein the detection component is used for starting detection when the liquid is not delivered inside the duct; wherein the liquid activates the detection component, the detecting component sends a signal to the signal processing component for subsequent processing.

The design is simple, economical and efficient. When the sensor detects the leakage, the signal would be transmitted to the operator and the operator could take emergency measures immediately. The device could also be connect with PLC control center. The central control system could shut down the power to stop the operation and prevent the possibilities of adverse consequences.

One object of the present invention is to provide a liquid delivery system with a detecting leakage of liquid, comprising: a duct, the duct is for conveying liquid; a valve, the valve is located at a predetermined position of the duct to control the flow of liquid; and a detecting module, the detecting module is located after the liquid outlet end of the valve and inside the duct; wherein the valve is closed to stop the delivery of the liquid, the detecting module starts detecting and generates a warning signal when the leakage of liquid occurs.

Preferably, wherein the detecting module further includes at least one detecting device and at least one signal processing device; wherein the detecting device is activated when the valve is closed to stop conveying liquid and a leakage of liquid is generated, then the detecting device generates a leakage signal to send to the signal processing device, and the signal processing device generates the warning signal.

Preferably, wherein the detecting device is an optical detecting device.

Preferably, wherein the detecting device is a capacitive detecting device.

Preferably, wherein the detecting device is a resistive detecting device.

One object of the present invention is to provide a detecting method of liquid leakage inside the duct, comprising: performing a delivery procedure, a duct is provided to perform the duct is filled with and continuously delivers liquid; performing a stopping delivery procedure, in order to stop the delivery of liquid inside the duct; performing a removal procedure for liquid, after the stopping delivery procedure, liquid is completely excluded in a specific area inside the duct; performing a detecting procedure for liquid leakage, when the specific area is in a clear state, to detect liquid is started, and a liquid-free signal is transmitted; performing a notification procedure for liquid leakage, after the detecting procedure for liquid leakage, liquid is detected in the specific area, then the notification procedure for liquid leakage transmits a liquid signal; and wherein liquid supply is required, liquid is supplied, and the delivery procedure is performed. After the delivery procedure is performed, the detecting procedure for liquid leakage and the notification procedure for liquid leakage are stopped.

Preferably, wherein between the removal procedure for liquid and detecting procedure for liquid leakage further includes performing an establishment starting point procedure for detecting leakage, when the specific area encounters the state of liquid-free the first time; wherein the establishment starting point procedure for detecting leakage is to determine the removal procedure for liquid is over.

Preferably, wherein one open of the specific area includes a valve in order to control the flow of liquid, wherein the valve is located at the liquid inlet.

Preferably, wherein the removal procedure for liquid, the establishment starting point procedure for detecting leakage and detecting procedure for liquid leakage is perform by a detecting module; wherein the detecting module further includes at least one detecting device and at least one signal processing device; wherein the detecting device is activated when the valve is closed to stop conveying liquid and a leakage of liquid is generated, then the detecting device generates a leakage signal to send to the signal processing device, and the signal processing device generates the warning signal; wherein the detecting device is located at the wall inside the duct in the specific area.

Preferably, wherein the detecting device is an optical detecting device.

Preferably, wherein the detecting device is a capacitive detecting device.

Preferably, wherein the detecting device is a resistive detecting device.

One object of the present invention is to provide a detecting system of liquid leakage inside a duct, which is used when the liquid is not transported inside the duct, the detecting system of liquid leakage inside a duct includes a detecting module, wherein the detecting module is located inside the duct and activated when the delivery of liquid is stopped and a leakage of liquid is generated, then the detecting module generates a warning signal.

Preferably, wherein the detecting module further includes at least one detecting device and at least one signal processing device; wherein the detecting device is activated when the liquid is stopped conveying and a leakage of liquid is generated, then the detecting device generates a leakage signal to send to the signal processing device, and the signal processing device generates the warning signal; wherein the detecting device is located at the wall inside the duct in the specific area.

Preferably, wherein the detecting device is an optical detecting device.

Preferably, wherein the detecting device is a capacitive detecting device.

Preferably, wherein the detecting device is a resistive detecting device.

### BRIEF DESCRIPTION OF THE DRAWINGS

FIG. 1 shows a chart of a detecting system of liquid leakage inside the duct according to the first embodiment of the present invention.

FIG. 2A shows a chart of a detecting system of liquid leakage inside the duct according to the second embodiment of the present invention.

FIG. 2B shows a chart of an optical detecting device inside the duct according to the second embodiment of the present invention.

FIG. 3A shows a chart of a detecting system of liquid leakage inside the duct according to the third embodiment of the present invention.

FIG. 3B and FIG. 3C shows a chart of a capacitive detecting device inside the duct according to the third embodiment of the present invention.

FIG. 4A shows a chart of a detecting system of liquid leakage inside the duct according to the fourth embodiment of the present invention.

FIG. 4B to FIG. 4E shows a chart of a resistive detecting device inside the duct according to the fourth embodiment of the present invention.

FIG. 5 shows a chart of a detecting system of liquid leakage inside the duct according to the fifth embodiment of the present invention.

FIG. 6 shows a chart of a detecting system of liquid leakage inside the duct according to the fifth embodiment of the present invention.

FIG. 7 shows a chart of a detecting system of liquid leakage inside the duct according to the fifth embodiment of the present invention.

FIG. 8 shows a chart of a detecting system of liquid leakage inside the duct according to the sixth embodiment of the present invention.

### DETAILED DESCRIPTION OF THE INVENTION

Reference will now be made in details to specific embodiment of the present invention. Examples of these embodiments are illustrated in the accompanying drawings. While the invention will be described in conjunction with these specific embodiments, it will be understood that the intent is not to limit the invention to these embodiments. In fact, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without at least one of these specific details. In other instances, the well-known portions are less or not described in detail in order not to obscure the present invention.

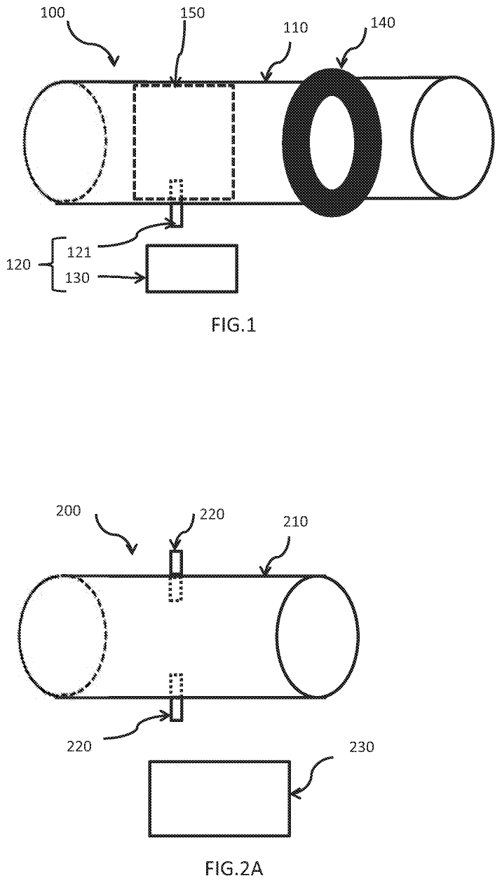

Referring to FIG. 1, a detecting system of liquid leakage inside the duct 100 is disclosed, which is used when the liquid is not transported inside the duct according to a first embodiment of the present invention. The detecting system 100 comprises: a duct 110, a valve 140, a detecting module 120. The duct 110 is for conveying liquid, and the valve is located at a predetermined position of said duct 110 to control the flow of the liquid. Moreover, the detecting module 120 is located after the liquid outlet end of said valve 140 and inside said duct 110, wherein said valve 140 is closed to stop the delivery of liquid, said detecting module 120 starts detecting and generates a warning signal when the leakage of liquid occurs.

Furthermore, the detecting module 120 further includes at least one detecting device 121 and at least one signal processing device 130; wherein the detecting device 121 is activated when said valve 140 is closed to stop conveying liquid and a leakage of liquid is generated, then said detecting device 121 generates a leakage signal to send to said signal processing device 130, and said signal processing device 130 generates the warning signal.

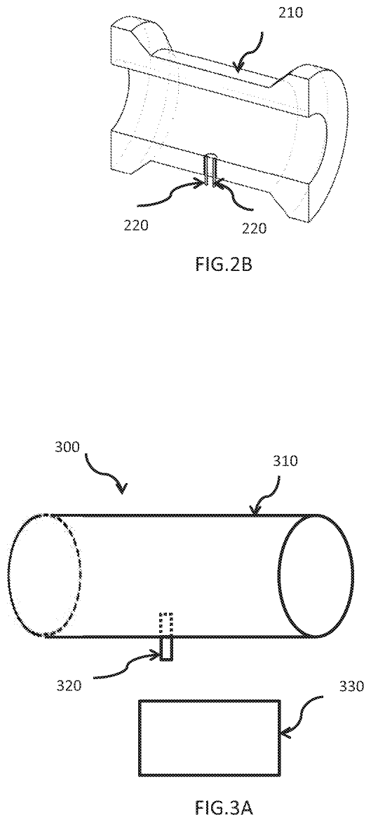

Referring to FIG. 2A, 2B, a detecting system of liquid leakage inside the duct 200 is disclosed, which is used when the liquid is not transported inside the duct according to a second embodiment of the present invention. The detecting system 200 comprises: a duct 210, an optical detecting device 220, a signal processing device 230. The optical detecting device 220 is penetrated and fixed to the wall inside the duct 210. Wherein, the optical detecting device 220 is a light blocking type. Wherein, the optical detecting device 220 is used for starting detection when the liquid is not delivered inside the duct 210. When the liquid activates the optical detecting device 220, the optical detecting device 220 sends a signal to the signal processing device 230 for subsequent processing.

The optical detecting device 220 described above is a group of light emitting elements and light receiving elements. There is a gap between the light-emitting element and the light-receiving element. If there is no object blocking in the gap, the light of the light-emitting element will directly illuminate the light-receiving element, and the output current is large; on the contrary, if an object blocks the light, the light is irradiated to make the output current small. There are three types of liquid leakage inside the duct 210: (1) no liquid inside the duct 210; (2) intermittent leakage of liquid inside the duct 210; and (3) continuous leakage of liquid inside the duct 210. Since inside the duct 210 is sealed and opaque, it is necessary to cooperate with the warning device to allow the user to clearly understand the situation inside the duct 210. When the situation is (1), when there is no liquid leakage inside the duct 210, the light receiving element continuously receives the light from the light emitting element, so the warning device has no action. When the situation is (2), when the liquid leaks intermittently inside the duct 210, the light emitted by the light-emitting element is intermittently refracted by the liquid, so that the light-receiving element cannot continuously receive the light, so the warning device intermittently emits a warning, which can be flashed or sounded by the light. When the situation is (3), when the liquid leaks or is filled with liquid inside the duct 210, the light emitted by the light-emitting element is continuously refracted by the liquid, and the light-receiving element cannot receive the light, so the warning device will continue to issue a warning.

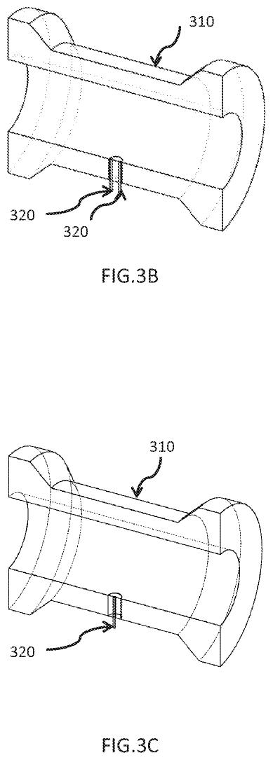

Referring to FIG. 3A, 3B, a detecting system of liquid leakage inside the duct 300 is disclosed, which is used when the liquid is not transported inside the duct according to a third embodiment of the present invention. The detecting system 300 comprises: a duct 310, a capacitive detecting device 320, a signal processing device 330. The capacitive detecting device 320 is penetrated and fixed to the wall inside the duct 310. Wherein, the capacitive detecting device 320 is a light blocking type. Wherein, the capacitive detection component 320 is used for starting detection when the liquid is not delivered inside the duct 310. When the liquid activates the capacitive detecting device 320, the capacitive detecting device 320 sends a signal to the signal processing device 330 for subsequent processing.

Referring to FIGS. 3B and 3C, the capacitive detecting device 320 described above is a system may be a two-point metal probe or single-point metal probes and metal pipes, wherein, the metal pipe is used as the second probe contact, wherein there is a gap between the metal probe and the metal pipe, and install the metal probe below the horizontal pipe. If no liquid exists between the gaps, the capacitive medium formed between the two point metal probes or between the single-point metal probe and the metal conduit is air. However, when a liquid is present, the capacitive medium between the two point metal probes or between the single-point metal probe and the metal conduit is the liquid to be tested, depending on the nature of the liquid present. Therefore, it is possible to recognize whether there is leakage liquid in the pipeline through the oscillation circuit by using the capacitance change. There are three expected conditions for leaking liquid in the pipeline when the valve is closed: (1) There is no liquid inside the duct 310; (2) Intermittent leakage of liquid inside the duct 310; (3) Continuous leakage of liquid inside the duct 310. Since the duct 310 is sealed and opaque, it is necessary to cooperate with the warning device to allow the user to clearly understand the situation inside the duct 310. When the situation is (1) When there is no liquid leakage inside the duct 310, the capacitance between the two metal detectors is approximately zero, and the oscillation circuit cannot generate an oscillation signal, so that the output of the peak sampling circuit is zero, lower than the adjustable reference voltage, so that the comparator output is zero, so the warning device has no action. When the situation is (2) When the liquid leaks intermittently inside the duct 310, since the capacitance between the two metal probes is intermittently increased to a few to a few dozen nF, The oscillating circuit generates a sinusoidal oscillation signal, peak sampling circuit output voltage is Intermittent and higher than adjustable reference voltage. The oscillating circuit generates a sinusoidal oscillation signal, peak sampling circuit output voltage is intermittent and higher than adjustable reference voltage, and comparators output is intermittent and high potential. Therefore, the warning device will intermittently issue a warning. When the situation is (3) When inside the duct 310 continues to leak liquid or is full of liquid, since the capacitance between the two metal probes is intermittently increased to a few dozen nF, The output of the peak sampling circuit will always be higher than the adjustable reference voltage. The comparator output will remain high for a long time, so the alert will continue to alert.

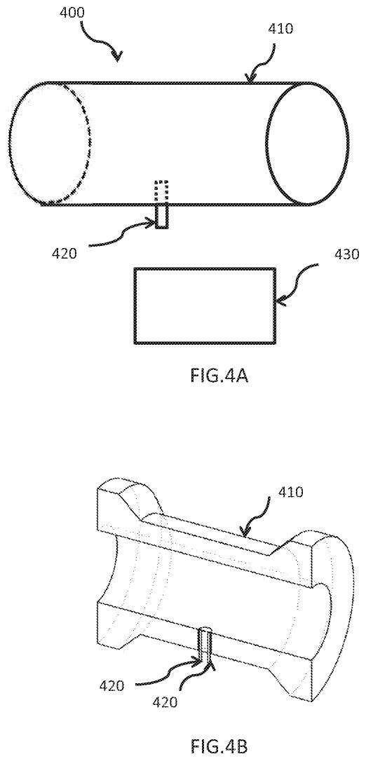

Referring to FIG. 4A, a detecting system of liquid leakage inside the duct 400 is disclosed, which is used when the liquid is not transported inside the duct according to a fourth embodiment of the present invention. The detecting system 400 comprises: a duct 410, a resistive detecting device 420, a signal processing device 430. The resistive detecting device 420 is penetrated and fixed to the wall inside the duct 410. Wherein, the resistive detecting device 420 is a light blocking type. Wherein, the resistive detecting device 420 is used for starting detection when the liquid is not delivered inside the duct 410. When the liquid activates the resistive detecting device 420, the resistive detecting device 420 sends a signal to the signal processing device 430 for subsequent processing.

Referring to FIGS. 4B and 4C, the resistive detecting device 420 described above is a system may be a two-point metal probe or single-point metal probes and metal pipes, wherein, the metal pipe is used as the second probe contact, wherein there is a gap between the metal probe and the metal pipe, and install the metal probe below the horizontal pipe. If no liquid exists between the gaps, the impedance formed between the two point metal probes or between the single-point metal probe and the metal conduit is infinite. Referring to FIGS. 4D and 4E, the resistive detecting device 420 described above is a system which may be a set of two or more metal probes. However, when a liquid is present, the impedance between the two point metal probes or between the single-point metal probe and the metal conduit will be reduced to tens to hundreds of kO, depending on the nature of the liquid present. Therefore, it is possible to identify whether there is leakage liquid in the pipeline through the voltage division and comparison circuit by using the resistance change. The feasible circuit includes a voltage dividing circuit as an integrated detection signal, a comparison circuit and an adjustable reference voltage signal. There are three expected conditions for leaking liquid inside the duct 410 when the valve is closed. (1) There is no liquid inside the duct 410; (2) Intermittent leakage of liquid inside the duct 410; (3) Continuous leakage of liquid or liquid inside the duct 410. Since the duct 410 is sealed and opaque, it is necessary to cooperate with the warning device to allow the user to clearly understand the situation inside the duct 410. When the situation is (1) When there is no liquid leakage inside the duct 410, the impedance between the two metal probes is infinite, the comparator output is zero, therefore, the warning device has no action. When the situation is (2) When the liquid leaks intermittently inside the duct 410, intermittent decrease in impedance between two metal probes when intermittently leaking liquid inside the duct 410, the voltage of the voltage dividing circuit is intermittently lower than the adjustable reference voltage. The comparator output will be intermittently high voltage, therefore, the warning device will intermittently issue a warning. When the situation is (3) When the pipeline continues to leak liquid or is full of liquid, the impedance between the two metal probes is reduced, the voltage of the voltage divider circuit will always be lower than the adjustable reference voltage. The comparator output will stay at high potential all the time.

Therefore, the warning device will continue to issue a warning.

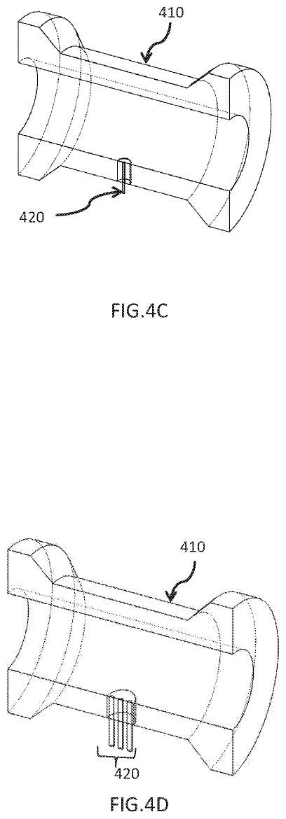

Referring to FIG. 5, a detecting system of liquid leakage inside the duct 500 is disclosed, which is used when the liquid is not transported inside the duct according to a fifth embodiment of the present invention. The detecting system 500 comprises: a duct 510, an annular resistance detecting device 520, a signal processing device 530. The annular resistance detecting device 520 is penetrated and fixed to the wall inside the duct 510. Wherein, the annular resistance detecting device 520 is a light blocking type. Wherein, the annular resistance detecting device 520 is used for starting detection when the liquid is not delivered inside the duct 510. When the liquid activates the annular resistance detection component 520, the ring resistance detecting device 520 sends a signal to the signal processing device 530 for subsequent processing.

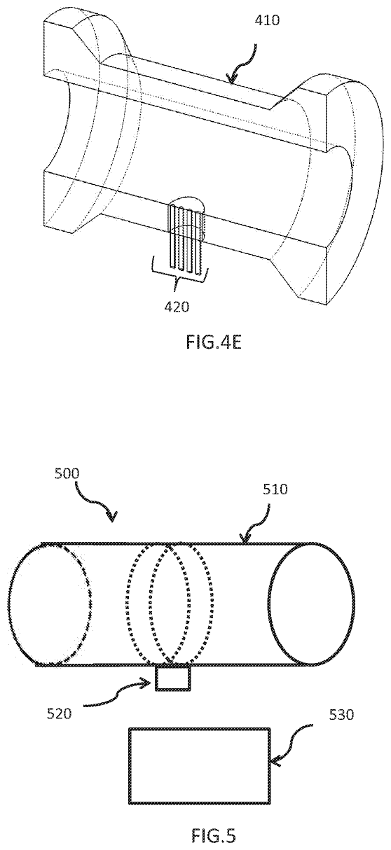

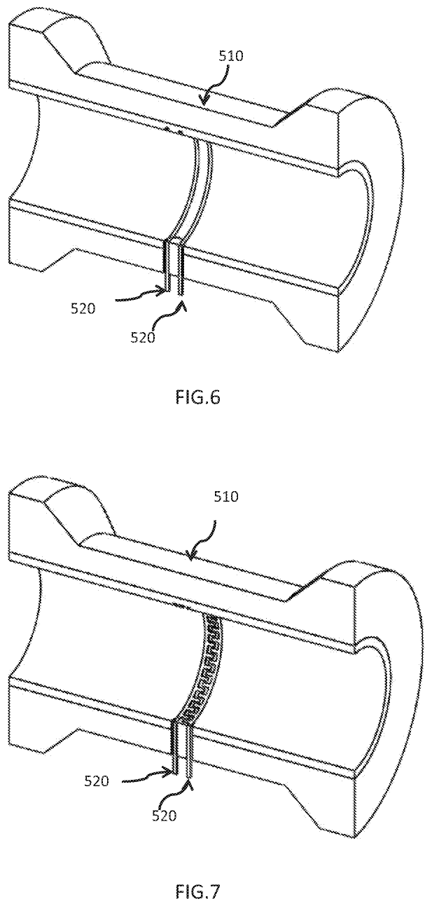

Referring to FIGS. 6 and 7, the annular resistance detecting device 520 described above is two annular metal probes which are flattened on the wall of inside the duct 510. If there is no liquid between the gaps, the impedance between the two metal probes is infinite. However, when there is liquid between the two metal probes, the impedance between the two metal probes will be reduced to tens to hundreds of kW according to the characteristics of the liquid present. Therefore, it is possible to identify the presence of leakage liquid inside the duct 510 through the voltage division and comparison circuit by using the resistance change. And because the probe is designed to be annular, as long as liquid flows along the pipe wall, it will affect the resistance between the two annular metal probes, so it can be installed in any angle pipe. The feasible circuit includes a voltage dividing circuit as an integrated detection signal, a comparison circuit and an adjustable reference voltage signal. There are three expected conditions for leaking liquid inside the duct 510 when the valve is closed. (1) There is no liquid inside the duct 510; (2) Intermittent leakage of liquid inside the duct 510; (3) Continuous leakage of liquid or liquid inside the duct 510. Since the duct 510 is sealed and opaque, it is necessary to cooperate with the warning device to allow the user to clearly understand the situation inside the duct 510. When the situation is (1) When there is no liquid leakage inside the duct 410, the impedance between the two metal probes is infinite, the comparator output is zero, therefore, the warning device has no action. When the situation is (2) When the liquid leaks intermittently inside the duct 510, intermittent decrease in impedance between two metal probes when intermittently leaking liquid inside the duct 510, the voltage of the voltage dividing circuit is intermittently lower than the adjustable reference voltage. The comparator output will be intermittently high voltage, therefore, the warning device will intermittently issue a warning. When the situation is (3) When the pipeline continues to leak liquid or is full of liquid, the impedance between the two metal probes is reduced, the voltage of the voltage divider circuit will always be lower than the adjustable reference voltage. The comparator output will stay at high potential all the time. Therefore, the warning device will continue to issue a warning.

The above annular metal probes can be two straight lines, as shown in FIG. 6, and it also can be opposite to the two comb lines, as shown in FIG. 7.

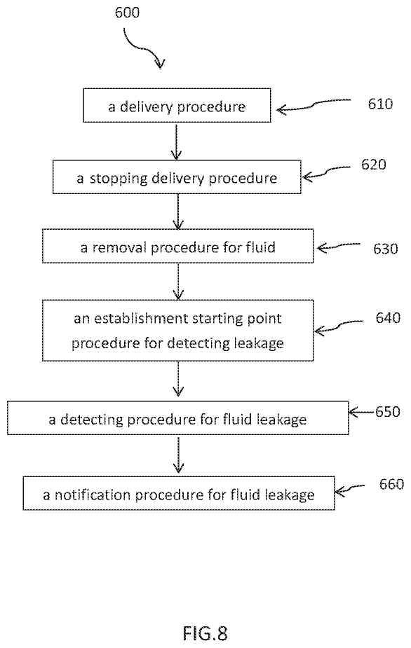

Referring to FIG. 8, a detecting method 600 of liquid leakage inside the duct is disclosed for use with a detecting system of liquid leakage inside the duct 100, which is used when the liquid is not transported inside the duct 100 according to a sixth embodiment of the present invention. First, a duct 110 is provided to perform a delivery procedure 610 so as to the liquid is delivered, wherein the delivery liquid passes through a detecting device 120. The detection component 120 is fixed to the wall inside the duct 110. A stopping delivery procedure 620 is performed when no liquid supply is required. After the stopping delivery procedure 620, the delivery of the liquid is stopped, and then a removal procedure for liquid 630 is performed to perform liquid evacuation on the detecting device 120 inside the duct 110. When the detecting device 120 encounters the first time without liquid, the detecting method 600 performs an establishment starting point procedure for detecting leakage 640, the detecting device 120 transmits a liquid-free signal to a signal processing device 130. After the establishment starting point procedure for detecting leakage 640, when detecting device 120 is in a liquid-free state, a detecting procedure for liquid leakage 650 is performed to detect liquid and the detecting device 120 transmits a liquid free signal to the signal processing device 130. After detecting procedure for liquid leakage 650, liquid is detected on the detecting device 120, the detecting method 600 performs a notification procedure for liquid leakage 660, the detecting device 120 transmits a liquid signal to the signal processing device 130. When liquid supply is required will carry out the delivery procedure 610. The liquid is conveyed inside the duct 110. After the delivery procedure 610, the Start detection leak to establish the starting point procedure 640, the detecting procedure for liquid leakage 650, and the notification procedure for liquid leakage 660 are stopped.

Variations of the methods, the devices, the systems and the applications as described above may be realized by one skilled in the art. Although the methods, the devices, the systems, and the applications have been described relative to specific embodiments thereof, the invention is not so limited. Many variations in the embodiments described and/or illustrated may be made by those skilled in the art. Accordingly, it will be understood that the present invention is not to be limited to the embodiments disclosed herein, can include practices other than specifically described, and is to be interpreted as broadly as allowed under the law.

What is claimed is:

1. A liquid delivery system with a detecting leakage of liquid, comprising:
a duct, said duct is for conveying liquid;
a valve, said valve is located at a predetermined position of said duct to control the flow of liquid; and
a detecting module, said detecting module is located after the liquid outlet end of said valve and inside said duct;
wherein said valve is closed to stop the delivery of liquid, said detecting module starts detecting and generates a warning signal when the leakage of liquid occurs.

2. The liquid delivery system with a detecting leakage of liquid as claimed in claim 1, wherein said detecting module further includes at least one detecting device and at least one signal processing device; wherein the detecting device is activated when said valve is closed to stop conveying liquid and a leakage of liquid is generated, then said detecting device generates a leakage signal to send to said signal processing device, and said signal processing device generates the warning signal.

3. The liquid delivery system with a detecting leakage of liquid as claimed in claim 2, wherein said detecting device is an optical detecting device.

4. The liquid delivery system with a detecting leakage of liquid as claimed in claim 2, wherein said detecting device is a capacitive detecting device.

5. The liquid delivery system with a detecting leakage of liquid as claimed in claim 2, wherein said detecting device is a resistive detecting device.

6. A detecting method of liquid leakage inside the duct, comprising:
performing a delivery procedure, a duct is provided to perform said duct is filled with and continuously delivers liquid;
performing a stopping delivery procedure, in order to stop the delivery of liquid inside said duct;
performing a removal procedure for liquid, after said stopping delivery procedure, liquid is completely excluded in a specific area inside said duct;
performing a detecting procedure for liquid leakage, when said specific area is in a clear state, to detect liquid is started, and a liquid-free signal is transmitted;
performing a notification procedure for liquid leakage, after said detecting procedure for liquid leakage, liquid is detected in said specific area, then said notification procedure for liquid leakage transmits a liquid signal; and
When liquid supply is required, liquid is supplied, and said delivery procedure is performed. After said delivery procedure is performed, said detecting procedure for liquid leakage and said notification procedure for liquid leakage are stopped.

7. The detecting method of liquid leakage inside the duct as claimed in claim 6, wherein between said removal procedure for liquid and detecting procedure for liquid leakage further includes performing an establishment starting point procedure for detecting leakage, when said specific area encounters the state of liquid-free the first time; wherein said establishment starting point procedure for detecting leakage is to determine said removal procedure for liquid is over.

8. The detecting method of liquid leakage inside the duct as claimed in claim 6, wherein one open of said specific area includes a valve in order to control the flow of liquid, wherein said valve is located at the liquid inlet.

9. The detecting method of liquid leakage inside the duct as claimed in claim 7, wherein said removal procedure for liquid, said establishment starting point procedure for detecting leakage and detecting procedure for liquid leakage is perform by a detecting module; wherein said detecting module further includes at least one detecting device and at least one signal processing device; wherein the detecting device is activated when the valve is closed to stop conveying liquid and a leakage of liquid is generated, then said detecting device generates a leakage signal to send to said signal processing device, and said signal processing device generates the warning signal; wherein said detecting device is located at the wall inside said duct in said specific area.

10. The detecting method of liquid leakage inside the duct as claimed in claim 9, wherein said detecting device is an optical detecting device.

11. The detecting method of liquid leakage inside the duct as claimed in claim 9, wherein said detecting device is a capacitive detecting device.

12. The detecting method of liquid leakage inside the duct as claimed in claim 9, wherein said detecting device is a resistive detecting device.

13. A detecting system of liquid leakage inside a duct, which is used when the liquid is not transported inside said duct, said detecting system of liquid leakage inside a duct includes a detecting module, wherein said detecting module is located inside said duct and activated when the delivery of liquid is stopped and a leakage of liquid is generated, then said detecting module generates a warning signal.

14. The detecting system of liquid leakage inside a duct as claimed in claim 13, wherein said detecting module further includes at least one detecting device and at least one signal processing device; wherein the detecting device is activated when the liquid is stopped conveying and a leakage of liquid is generated, then said detecting device generates a leakage signal to send to said signal processing device, and said signal processing device generates the warning signal; wherein said detecting device is located at the wall inside said duct in said specific area.

15. The detecting system of liquid leakage inside a duct as claimed in claim 14, wherein said detecting device is an optical detecting device.

16. The detecting system of liquid leakage inside a duct as claimed in claim 14, wherein said detecting device is a capacitive detecting device.

17. The detecting system of liquid leakage inside a duct as claimed in claim 14, wherein said detecting device is a resistive detecting device.
